(19) United States
(12) Patent Application Publication
(10) Pub. No.: US 2015/0051973 A1
(43) Pub. Date: Feb. 19, 2015

(54) CONTEXTUAL-BANDIT APPROACH TO PERSONALIZED NEWS ARTICLE RECOMMENDATION

(71) Applicant: Yahoo! Inc., Sunnyvale, CA (US)

(72) Inventors: Lihong Li, Santa Clara, CA (US); Wei Chu, San Jose, CA (US); John Langford, White Plains, NY (US); Robert Schapire, New York, NY (US)

(21) Appl. No.: 14/468,130

(22) Filed: Aug. 25, 2014

Related U.S. Application Data
(62) Division of application No. 12/836,188, filed on Jul. 14, 2010.

(51) Int. Cl. G06Q 30/02

(52) U.S. Cl. CPC G06Q 30/0255; G06Q 30/0269
USPC 705/14.53

(57) ABSTRACT

Methods and apparatus for performing computer-implemented personalized recommendations are disclosed. User information pertaining to a plurality of features of a plurality of users may be obtained. In addition, item information pertaining to a plurality of features of the plurality of items may be obtained. A plurality of sets of coefficients of a linear model may be obtained based at least in part on the user information and/or the item information such that each of the plurality of sets of coefficients corresponds to a different one of a plurality of items, where each of the plurality of sets of coefficients includes a plurality of coefficients, each of the plurality of coefficients corresponding to one of the plurality of features. In addition, at least one of the plurality of coefficients may be shared among the plurality of sets of coefficients for the plurality of items. Each of a plurality of scores for a user may be calculated using the linear model based at least in part upon a corresponding one of the plurality of sets of coefficients associated with a corresponding one of the plurality of items, where each of the plurality of scores indicates a level of interest in a corresponding one of a plurality of items. A plurality of confidence intervals may be ascertained, each of the plurality of confidence intervals indicating a range representing a level of confidence in a corresponding one of the plurality of scores associated with a corresponding one of the plurality of items. One of the plurality of items for which a sum of a corresponding one of the plurality of scores and a corresponding one of the plurality of confidence intervals is highest may be recommended.

### RELATED APPLICATIONS

This application is a divisional application and claims priority from U.S. patent application Ser. No. 12/836,188, Attorney Docket No. YAH1P261/Y06163US00, entitled “A CONTEXTUAL-BANDIT APPROACH TO PERSONALIZED NEWS ARTICLE RECOMMENDATION,” by Li et al, filed on Jul. 14, 2010, which is incorporated herein in its entirety and for all purposes.

### BACKGROUND OF THE INVENTION

The present invention relates generally to computer implemented personalized recommendation based upon contextual information.

Today, many web sites strive to personalize their web services to individual users who visit the web sites. However, personalizing web services is a difficult endeavor. First, web services often feature content that is dynamically changing at a rapid pace. Second, the scale of most web services calls for solutions that can rapidly process a vast amount of data. Third, a significant number of visitors are likely to be entirely new with no historical information available. These issues make traditional recommender methods difficult to apply in many scenarios.

### SUMMARY OF THE INVENTION

Methods and apparatus for providing a personalized recommendation of an item from a pool of items are disclosed. The disclosed embodiments may apply regardless of whether items in the pool change over time (e.g., in number, identity and/or content).

In accordance with one aspect, information (e.g., values of a plurality of features) pertaining to a plurality of users is obtained, where the information indicates a response of the plurality of users with respect to a plurality of items. A plurality of scores may be generated for a user based at least in part on at least a portion of the information pertaining to the plurality of users, where each of the plurality of scores indicates a level of interest of the user in a corresponding one of the plurality of items. The user may or may not be one of the plurality of users. A plurality of confidence intervals are ascertained, where each of the plurality of confidence intervals indicates a range representing a level of confidence in a corresponding one of the plurality of scores. One of the plurality of items for which a sum of a corresponding one of the plurality of scores and a corresponding one of the plurality of confidence intervals is highest may be identified. The identified one of the plurality of items may then be provided or recommended in association with the user.

In accordance with another aspect, values of a plurality of features pertaining to a plurality of users may be obtained. A plurality of scores for one of the plurality of users may be generated based at least in part on at least a portion of the values of the plurality of features pertaining to the plurality of users, where each of the plurality of scores indicates a level of interest of the user in a corresponding one of a plurality of items. A plurality of confidence intervals may be ascertained, where each of the plurality of confidence intervals indicates a range representing a level of confidence in a corresponding one of the plurality of scores for a corresponding one of the plurality of items. One of the plurality of items for which a sum of a corresponding one of the plurality of scores and a corresponding one of the plurality of confidence intervals is highest may be identified. The identified one of the plurality of items may then be provided or recommended in association with the user.

In accordance with yet another aspect, user information pertaining to a plurality of features (e.g., demographic and/or behavioral features) of a plurality of users may be obtained. In addition, item information pertaining to a plurality of features of the plurality of items may be obtained. A plurality of sets of coefficients of a linear model may be obtained based at least in part on the user information and/or item information such that each of the plurality of sets of coefficients corresponds to a different one of a plurality of items, where each of the plurality of sets of coefficients includes a plurality of coefficients, each of the plurality of coefficients corresponding to a different one of the plurality of features. In addition, at least one of the plurality of coefficients may be shared among the plurality of sets of coefficients for the plurality of items. Each of a plurality of scores for a user may be calculated using the linear model based upon a corresponding one of the plurality of sets of coefficients associated with a corresponding one of the plurality of items, where each of the plurality of scores indicates a level of interest in a corresponding one of a plurality of items (e.g. based upon the values of the features of the users). The user may or may not be one of the plurality of users. One of the plurality of items may then be recommended based at least in part on the plurality of scores.

In one embodiment, a plurality of confidence intervals may be ascertained, where each of the plurality of confidence intervals indicates a range representing a level of confidence in a corresponding one of the plurality of scores that has been generated. One of the plurality of items for which a sum of a corresponding one of the plurality of scores and a corresponding one of the plurality of confidence intervals is highest may be ascertained, where recommending or providing one of the plurality of items based at least in part on the plurality of scores is performed by recommending or providing the identified one of the plurality of items.

In accordance with another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a block diagram illustrating an example system in which various embodiments may be implemented.

FIG. 2 is a diagram illustrating an example graphical user interface via which an item may be recommended in accordance with various embodiments.

FIG. 3 is a diagram illustrating an example LinUCB algorithm with disjoint linear models.

FIG. 4 is a diagram illustrating an example LinUCB algorithm with hybrid linear models.

FIGS. 5A-C are process flow diagrams that together illustrate example methods of recommending one of a plurality of items in accordance with various embodiments.

FIG. 6 is a simplified diagram of an example network environment in which various embodiments may be implemented.

FIG. 7 illustrates an example computer system in which various embodiments may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

It is often a challenge for web services to identify the most appropriate web-based content for an individual user at a given point in time (e.g., when the user visits a web site or web page). Most service vendors acquire and maintain information pertaining to a large number of content items such as news articles in their repository. The service vendors may use this information for filtering the content items or for the display of advertisements. However, the content of such a web-service repository typically changes dynamically, undergoing frequent additions and deletions (e.g., as current news articles are added and older news articles are deleted). In such a setting, it is important to quickly identify interesting content for a user. For example, a news filter may promptly identify the popularity of breaking news, while also adapting to the fading value of existing, aging news stories.

It is generally difficult to model popularity and temporal changes based solely on content information. In practice, users' feedback is typically collected in real time to evaluate the popularity of news content over time. In addition, traffic should be distributed to new content to learn its popularity more quickly.

Recently, personalized recommendation has become a desirable feature for websites to improve user satisfaction by tailoring content presentation to suit individual users' needs. Personalization generally involves a process of gathering and storing information associated with users, managing content assets, and delivering the best content to the present user accessing the website based, at least in part, upon the information gathered for various users over time. The user information may include demographic information and behavioral information indicating the users' behavior over time.

Often, both user information and content are represented by sets of attributes, which may be referred to as features. User features may include demographic attributes (e.g., gender, geographical location, age) and behavioral attributes such as user click behavior, purchase behavior, electronic mail behavior, etc. Content features may include descriptive information (e.g., summaries or abstracts) and/or categories in which content items may be categorized. Since the views of different users on the same content can vary significantly, user information may be gathered at the individual level. Moreover, since there may be a very large number of possible choices or actions available, it is desirable to recognize commonalities between content items and to transfer that knowledge across the content pool.

Traditional recommender systems, including collaborative filtering, content-based filtering and hybrid approaches, can provide meaningful recommendations at an individual level by leveraging users' interests as demonstrated by their past activity. Collaborative filtering, which involves recognizing similarities across users based on their behavioral attributes (e.g,. click behavior), provides a good recommendation solution to the scenarios where overlap in historical click behavior across users is relatively high and the content universe is almost static. Content-based filtering helps to identify new items which well match an existing user's consumption profile indicating the user's prior click behavior. However, the new items will be similar to the content items previously selected (e.g., clicked) by the user. Hybrid approaches have been developed by combining two or more recommendation techniques. For example, the inability of collaborative filtering to recommend new items may be alleviated by combining it with content-based filtering.

However, in many scenarios, the pool of content items undergoes frequent changes, with content popularity changing over time as well. More particularly, the number of content items in the pool, the identity of the content items in the pool, and/or the content of one or more of the content items in the pool may change over time. Furthermore, a significant number of visitors are likely to be entirely new with no historical click history. These issues make traditional recommender-system approaches difficult to apply. Therefore, it would be useful to be able to learn the goodness of a match between user interests and content when one or both of them are new. However, acquiring such information can be expensive and may reduce user satisfaction in the short term, raising the question of optimally balancing two competing goals: maximizing user satisfaction for present users, and gathering information about the goodness of a match between user interests and content to maximize user satisfaction in the long run.

In order to describe a specific implementation of the disclosed embodiments, the examples set forth herein will be described with reference to the recommendation of a news article. However, it is important to note that these examples are merely illustrative, and the disclosed embodiments may be applied to recommend other types of documents or items.

A document may be defined as a Uniform Resource Locator (URL) that identifies a location at which the document can be located. The document may be located on a particular web site, as well as a specific web page on the web site. For instance, a first URL may identify a location of a web page at which a document is located, while a second URL may identify a location of a web site at which the document can be located.

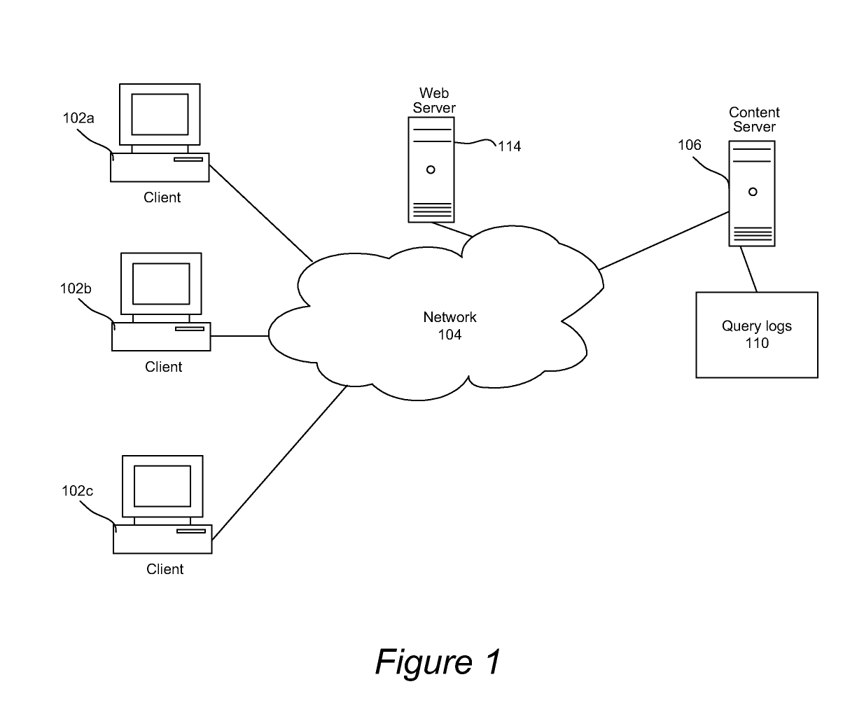

FIG. 1 illustrates an example network segment in which various embodiments of the invention may be implemented. As shown, a plurality of clients 102a, 102b, 102c may access a search application, for example, on search server 106 via network 104 and/or access a web service, for example, on web server 114 via a graphical user interface, as will be described in further detail below. The network may take any suitable form, such as a wide area network or Internet and/or one or more local area networks (LAN's). The network 104 may include any suitable number and type of devices, e.g., routers and switches, for forwarding search or web object requests from each client to the search or web application and search or web results back to the requesting clients.

The invention may also be practiced in a wide variety of network environments (represented by network 104) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

Many search services provide access to a number of sources of information. For example, Yahoo! provides access to various news sources, enabling users to read and search for news articles of interest to them. News articles retrieved from various web sites may be categorized among multiple categories such as Entertainment, Sports, and Finance. Users may therefore easily identify a category of news that interests them prior to attempting to access news articles in that particular category.

A search application generally allows a user (human or automated entity) to search for information that is accessible via network 104 and related to a search query including one or more search terms. The search terms may be entered by a user in any manner. Typically, a search website presents a graphical user interface to a client so that the client can enter a search query. For example, a user can enter a query including one or more search term(s) into an input feature of a graphical user interface presented via a search web page and then initiate a search based on such entered search term(s). In response to the query, a web search engine generally returns an ordered list of search result documents.

A search service may also offer personalized recommendation of documents such as news articles, as will be described in further detail below. More particularly, when a user accesses a search service's web page, the search service may automatically provide one or more documents (e.g., news articles) that would most likely be of interest to that user without requiring input from the user. This may be accomplished by providing one or more documents (e.g., links to the document(s)) via the website.

One way that a search service may obtain behavioral data for a user is to track the user's behavior in response to search results provided based upon searches initiated by the user via the search service's website. In addition, the search service may obtain further behavioral data by tracking user behavior in response to recommended documents (which have been provided automatically without input from the user). In order to update this behavioral data, the search server 106 (or servers) may have access to one or more query logs 110 into which behavioral data is retained. For example, the query logs 110 may be retained in one or more memories that are coupled to the search server 106.

More particularly, each time a user performs a search on one or more search terms, information regarding such search may be retained in the query logs 110. For instance, the user's search request may contain any number of parameters, such as user or browser identity and the search terms, which may be retained in the query logs 110. Additional information related to the search, such as a timestamp, may also be retained in the query logs 110 along with the search request parameters. When results are presented to the user based on the entered search terms, parameters from such search results may also be retained in the query logs 110. For example, the specific search results, such as the web sites, the order in which the search results are presented, whether each search result is a sponsored or algorithmic search result, the owner (e.g., web site) of each search result, whether each search result is selected (i.e., clicked on) by the user (if any), and/or a timestamp may also be retained in the query logs 110.

Similarly, when one or more documents are recommended to the user, the user's response to the recommended documents may also be retained in the query logs. More particularly, when one or more recommended documents are presented to the user, parameters from the user's response to the recommended documents may also be retained in the query logs 110. For example, the specific recommended document(s), such as the web sites, the order in which the documents are presented, the owner (e.g., web site) of each recommended document, whether each recommended document is selected (i.e., clicked on) by the user (if any), and/or a timestamp indicating a time when the recommended document was provided or selected may also be retained in the query logs 110. Furthermore, the query logs 110 may maintain information for a plurality of users.

Additional user information such as demographic information may also be maintained for each user. For example, a user's account established via a search website may indicate the user's geographical location (e.g., address), sex, age, educational background, profession and/or other demographic information such as the user's purchase history. In addition, information such as the user's purchase history may also be tracked via the search website.

Additional information associated with each document (e.g., news article) (or item) may also be maintained. For example, information indicating the popularity of a document or item (e.g., based upon click or purchase history) may be maintained. In addition, information pertaining to the content of a document or item (e.g., abstract, summary, key words, and/or hypertext link) may also be stored.

Based upon information in the query logs 110, additional user information and/or document information, the search website may identify one or more documents to recommend to a particular user, as will be described in further detail below. For each recommended document (or search result), the search server 106 may identify and present the appropriate web page(s) via a portion of the graphical user interface, as will be described in further detail below. For instance, the search server 106 may identify and present one or more hypertext links that identify different content items. In addition, the search server 106 may present a summary/abstract and/or photo associated with each of the hypertext links. The information that is available may be processed and displayed in accordance with various embodiments of the invention.

Embodiments disclosed herein may be implemented via the search server (or other server) 106 and/or the clients 102a, 102b, 102c. For example, various features may be implemented via a web browser and/or application on the clients 102a, 102b, 102c. The disclosed embodiments may be implemented via software and/or hardware.

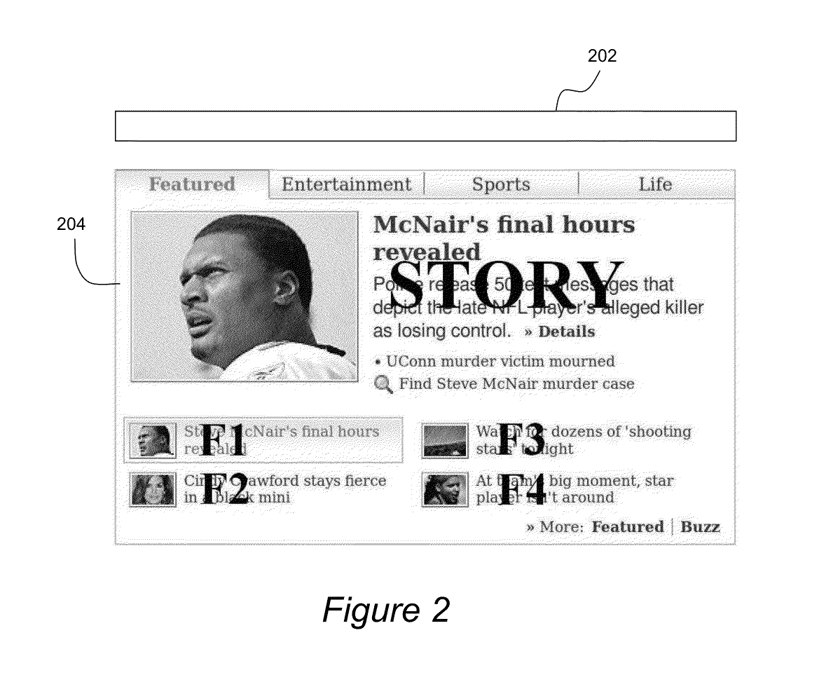

FIG. 2 is a diagram illustrating an example graphical user interface via which an item may be recommended in accordance with various embodiments. A graphical user interface provided via a search website's web page may present an input feature 202 to the client so the client can enter a query including one or more search term(s). In addition, the graphical user interface may include one or more segments via which one or more documents such as news articles may be presented as search results and/or personalized recommendations. As shown in this example, a segment 204 of the graphical user interface may present a featured document (e.g., news article) that is recommended to a user. This segment may be referred to as “Today Module,” which features a document that is recommended for the current day. For example, a particular news article may be identified as closely matching a user's interests (e.g., based upon information pertaining to the user and/or other users), and therefore may be highlighted in the segment 204. The document that is highlighted in the segment 204 may be the document at the F1 position, as shown. Highlighting of a particular document may be accomplished by providing a photo associated with the document, title of the document, and/or document summary, as shown in this example.

Moreover, search results may be provided in accordance with one or more of a plurality of content types or categories, which may be referred to as properties. Each of the plurality of content types or categories may correspond to a different search application, search engine, search web site, data source, and/or database. Example content types or categories may include “News,” “Sports,” or “Finance.” The plurality of content types or categories may be selectable by a user. As a result, the user may designate those content types or categories for which search results are desired. For instance, the user may select one or more content types or categories via one of a plurality of tabs. These content types/categories may be saved as the user's “Favorites.” In addition, the content types/categories identified as the user's “Favorites” may be modified (e.g., added or deleted) or recommended in accordance with the disclosed embodiments.

Multi-armed Bandit Formulation

The problem of personalized recommendation of documents (e.g., news articles), items, or content types/categories can be modeled as a multi-armed bandit problem with context information, which is generally referred to as a contextual bandit. A contextual bandit problem is an approach in which a learning algorithm sequentially selects articles to serve users based on contextual information of the user and articles, while simultaneously adapting its article-selection strategy based on user-click feedback to maximize total user clicks over time. A contextual-bandit algorithm A typically proceeds in discrete trials t=1, 2, 3, . . . , where each trial corresponds to a different one of a plurality of users. Generally, in trial t:

1. The algorithm A observes the current user uₜ and a set Aₜ of arms or actions together with their feature vectors x_{t,a} for a ∈Aₜ. The feature vector x_{t,a} may summarize information (e.g., features) of both the user uₜ and arm a, and may be referred to as the context.

2. Based on observed payoffs in previous trials, A chooses an arm aₜ∈Aₜ, and receives payoff r_{t,α}_{ₜ}, whose expectation depends on both the user uₜ and the arm aₜ.

3. The algorithm then improves its arm-selection strategy with the new observation, (x_{t,a}, aₜ, r_{t,α}_{ₜ}). No feedback (namely, the payoff r_{t,α}_{ₜ}), is observed for unchosen arms. The consequence of this fact will be discussed in further detail below.

In the process above, the total trial payoff for all trials T (and corresponding users) of the algorithm A is defined as Σₜ₌₁^{T}r_{t,α}_{ₜ}. Similarly, we can define the optimal expected trial payoff over all trials T as E [Σₜ₌₁^{T}r_{t,α}_{ₜ}*], where αₜ* is the arm with maximum expected payoff at trial t. Thus, an algorithm A may be designed in order to maximize the expected total payoff. Equivalently, an algorithm A can be defined so that its regret with respect to the optimal arm-selection strategy is minimized. The T-trial regret R_{A}(T) of algorithm A over all trials T can be defined formally by:

R_{A}(T)=E[Σₜ₌₁^{T}r_{t,α}_{ₜ}*]−E[Σₜ₌₁^{T}r_{t,α}_{ᵢ}] (1)

A special case of the general contextual bandit problem is the well-known K-armed bandit in which (i) the arm set Aₜ remains unchanged and contains K arms for all t, and (ii) the user uₜ (or equivalently, the context (x_{t,1}, . . . , x_{t,k})) is the same for all t. Since both the arm set and contexts are constant at every trial, they make no difference to the bandit algorithm, and so we can refer to this type of bandit as a context-free bandit.

In the context of document (e.g., news article) recommendation, we can view documents in the pool as arms. When a presented document is clicked, a payoff of 1 is incurred; otherwise, the payoff is 0. With this definition of payoff, the expected payoff of an article is its click through rate (CTR), and choosing an article with maximum CTR is equivalent to maximizing the expected number of clicks from users, which in turn is the same as maximizing the total expected payoff in the bandit formulation set forth above.

In addition, web services often have access to user information that can be used to infer a user's interest and to choose news articles that are likely most interesting to her. For example, it is much more likely for a male teenager to be interested in an article about iPod products rather than retirement plans. Therefore, users and articles can be “summarized” by a set of informative features that describe them. These features may be represented as feature vectors for the users and arms (e.g., news articles). Therefore, a bandit algorithm can generalize CTR information from one article/user to another, and learn to choose good articles more quickly, particularly for new users and articles.

Existing Bandit Algorithms

A fundamental challenge in bandit problems is balancing exploration and exploitation. Exploration typically refers to the process of maximizing clicks by identifying an optimum selection for a particular user from a pool of available documents based upon information about the user that is currently available, while exploitation typically refers to the process of gathering information about a user based upon the user's reaction to a particular document that is presented to the user (e.g., whether the user clicks on the document).

In order to minimize the regret R_{A}(T) in Equation (1), an algorithm A exploits its past experience to select the arm that appears best. However, this seemingly optimal arm may in fact be suboptimal, due to imprecision in A's knowledge. In order to avoid this undesired situation, A explores by choosing seemingly suboptimal arms so as together more information about them. Exploration can increase short-term regret since some suboptimal arms may be chosen. However, obtaining information about the arms' average payoffs (e.g., exploration) can refine A's estimate of the arms' payoffs and in turn reduce long-term regret. Thus, neither a purely exploring nor a purely exploiting algorithm works best in general.

Contextual Bandit Approach to Personalized Recommendation

While context-free K-armed bandits have been extensively studied, the more general contextual bandit problem has remained challenging. Many of the solutions to the general contextual bandit problem require extensive offline engineering, and are computationally prohibitive without coupling with approximation techniques.

In accordance with various embodiments, a confidence interval for each arm (e.g., document) can be computed efficiently in closed form when the payoff model is linear. This algorithm may be referred to as LinUCB, which refers to a linear algorithm that selects the arm that achieves a highest upper confidence bound (UCB). The UCB refers to the sum of the “score” for a particular arm and the confidence interval for that arm. Although the examples described herein refer to news articles, it is important to note that this generic contextual bandit algorithm may be applied to the personalized recommendation of items other than documents or news articles.

LinUCB with Disjoint Linear Models

A disjoint linear model is a model in which parameters (i.e., coefficients) are not shared among different arms. We assume that the expected payoff of an arm a is linear in its d-dimensional feature x_{t,a} with some unknown coefficient vector, θ*_{α}; namely, for all t:

E[r_{t,z}|x_{t,a}|=x_{t,α}^{T}θ*_{α}. (2)

Let Dₐ be a design matrix of dimension m x d at trial t, whose rows correspond to m training inputs (e.g., m contexts that are observed previously for article a), and cₐ∈R^{m} be the corresponding response vector (e.g., the corresponding m click/no-click user feedback). Each context may include a plurality of features for a user. In addition, the context may also include a plurality of features of the document. Applying ridge regression to historical or training data (Dₐ, cₐ) gives an estimate of the coefficients:

θ_{α}=(D_{α}^{T}D_{α}+I_{d})⁻¹D_{α}^{T}c_{α}, (3)

where I_{d} is the d x d identity matrix. When components in cₐ are independent conditioned on corresponding rows in Dₐ, it can be shown that, with a probability of at least 1−δ,

|x_{t,α}^{T}θ_{α}−E┌r_{t,α}|x_{t,α}┐≦α√x_{t,α}(D_{α}^{T}D_{α}+I_{d})⁻¹x_{t,α} (4)

for any δ>0 and x_{t,a}∈R^{d}, where α=1+√1n(2/δ)/2 is a constant. In other words, the inequality above gives a reasonably tight UCB (upper confidence bound) for the expected payoff of arm a, from which a UCB-type arm-selection strategy can be derived: at each trial t, choose

$${a}_{t} {=}^{def} arg {max}_{a ∈ {A}_{t}} ( {x}_{t , a}^{T} {θ}_{a} + α \sqrt{{x}_{t , a}^{T} {A}_{a}^{- 1} {x}_{t , a}} ) , \qquad ( 5 )$$

where

$${A}_{a} {=}^{def} {D}_{a}^{T} {D}_{a} + {I}_{d} .$$

The amount √x_{t,α}(D_{α}^{T}D_{α}+I_{d})⁻¹x_{t,α} Equation (4) may be referred to as a confidence interval for a particular arm, which is equivalent to √x_{t,α}^{T}A_{α}⁻¹x_{t,α} in Equation (5). The confidence interval may also be derived from other principles, such as a Bayesian point estimate or entropy reduction in information theory. The term θ_{α} in Equation (5) may represent the coefficients for a particular arm that have been derived via ridge regression. In other words, a different coefficient vector θ_{α} is associated with each arm. For example, the coefficient vector θ_{α} may include a plurality of coefficients, where each of the coefficients corresponds to a different feature in feature vector x_{t,α}. The amount x_{t,α}^{T}θ_{α} may be a score that represents the desirability of the arm a to user t. As a result, a different linear equation may be solved for each arm for user t.

The LinUCB algorithm selects the arm that achieves a highest upper confidence bound (UCB), as represented by Equation (5). The UCB refers to the sum of the “score” for a particular arm and the confidence interval for that arm. Upon selection of the arm, the arm (e.g., news article) may be presented or recommended to the user t.

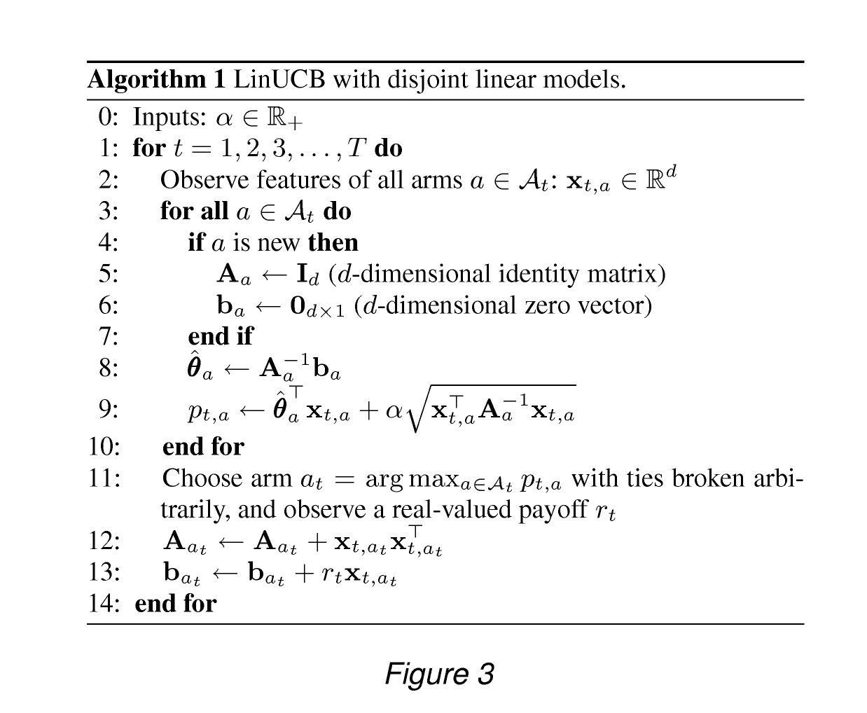

An example of the application of the LinUCB with disjoint linear models, Algorithm 1, is shown in FIG. 3. In the example shown in FIG. 3, the only input parameter is α. In practice, the value of α may be optimized to result in higher total payoffs.

In this example, the computational complexity of the algorithm is linear in the number of arms and at most cubic in the number of features. To decrease computation further, we may update Aₐ in each step, but compute and cache

$${Q}_{a} {=}^{def} {A}_{a}^{- 1}$$

(for all a) periodically instead of in real time. The algorithm also works well for a dynamic arm set, and remains efficient as long as the size of arm set Aₜ is not too large.

Furthermore, it is important to note that since the algorithm applies to all users T, the data for the users T may be applied in “cold start” situations. A cold start is generally understood to refer to a situation in which data for a particular user t has not previously been collected (e.g., where the user has not previously visited the web site). Therefore, data collected for all users T may be applied to select an arm for a user t for which data has not previously been collected.

LinUCB with Hybrid Linear Models

The above-described model may be modified to generate a hybrid linear model. A hybrid linear model is a model in which one or more parameters are shared among all of the different arms. In other words, one or more of the coefficients of a coefficient vector θₓ is shared among the different arms (e.g., news articles).

In many applications, it is helpful to use features that are shared by all arms, in addition to arm-specific features. For example, in news article recommendation, a user may prefer only articles about politics for which this provides a mechanism. Therefore, it is helpful to have features that have both shared and non-shared components. Specifically, a first set of one or more features may have shared components, while a second set of one or more features may not have shared components. The hybrid model may be represented by adding another linear term to the right-hand side of Equation (2):

E[r_{t,a}|x_{t,a}|=x_{t,α}^{T}θ*_{α}.+z_{t,α}^{T}β*, (6)

where z_{t,a}∈R^{k} is the feature of the current user/article combination and β* is an unknown coefficient vector common to all arms. Therefore, a first set of one or more coefficients (corresponding to the first set of one or more features having shared components) β* is shared by all arms, while other coefficients θ_{α}* are not shared by the arms.

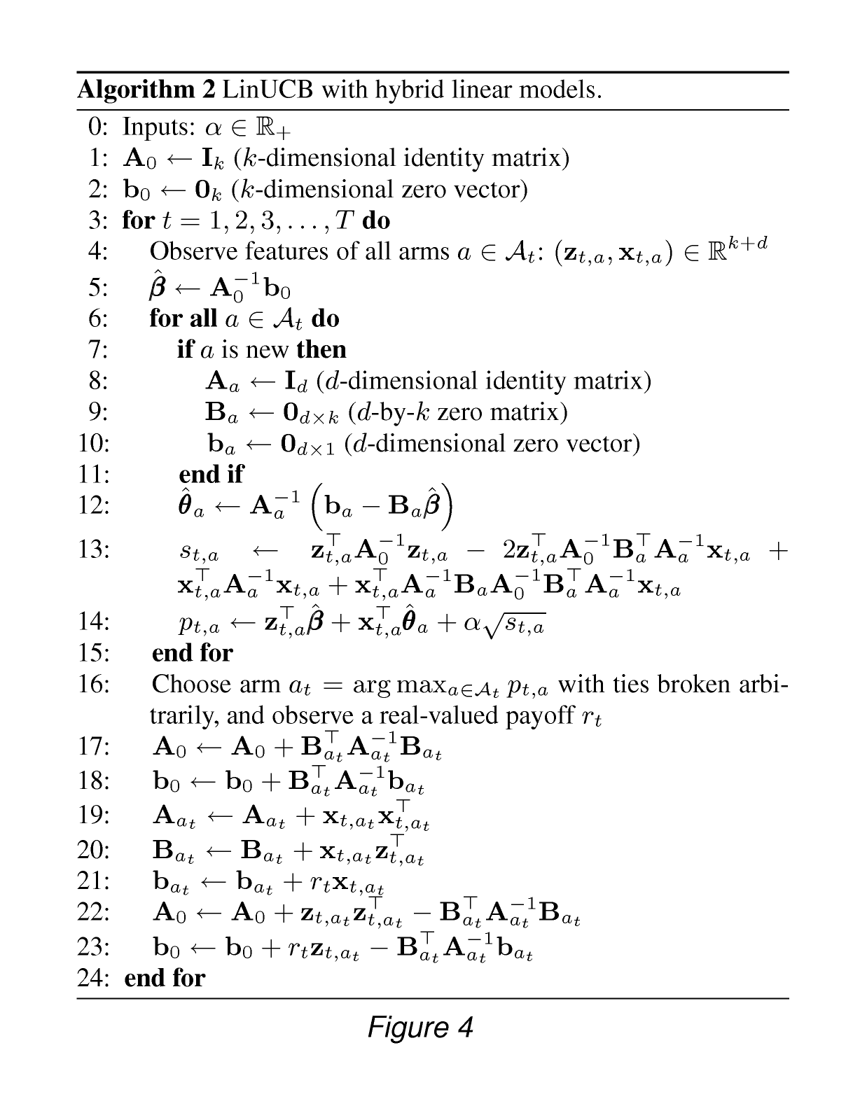

An example of the application of the LinUCB with hybrid linear models, Algorithm 2, is shown in FIG. 4. As shown in FIG. 4, lines 5 and 12 compute the ridge-regression solution of the coefficients, while line 13 computes the confidence interval for a particular arm (and user).

Thus, the confidence intervals incorporate the shared coefficients of the shared features. It is important to note that algorithm 2 is computationally efficient since the building blocks in the algorithm (A₀, b₀, Aₐ, Bₐ, and bₐ) all have fixed dimensions and can be updated incrementally. Furthermore, quantities associated with arms not existing in Aₜ no longer get included in the computation. Finally, we can also compute and cache the inverses (A₀⁻¹ and Aₐ⁻¹) periodically instead of at the end of each trial to reduce the per-trial computational complexity.

Applying LinUCB

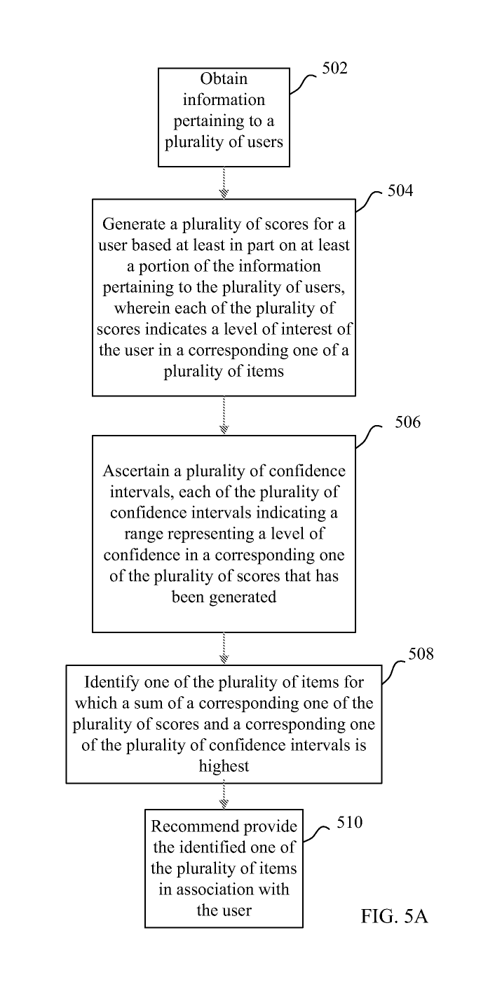

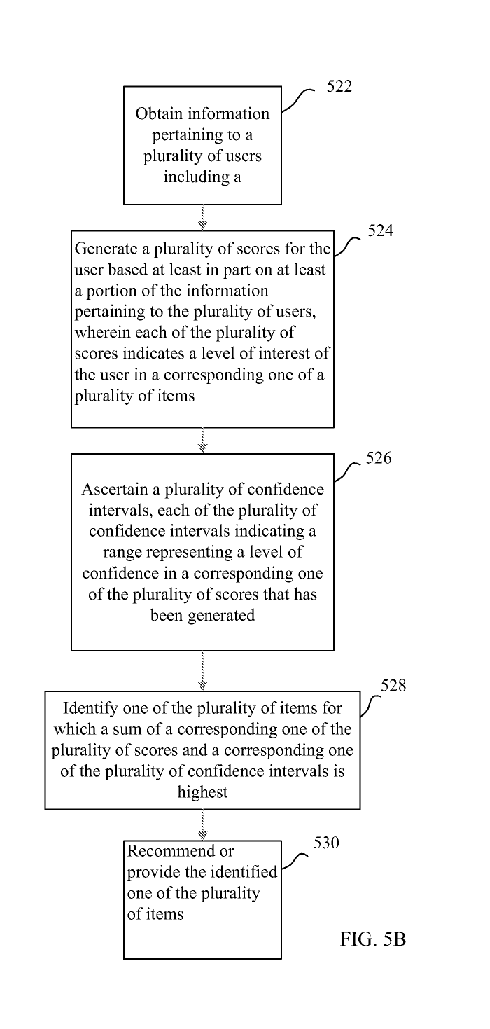

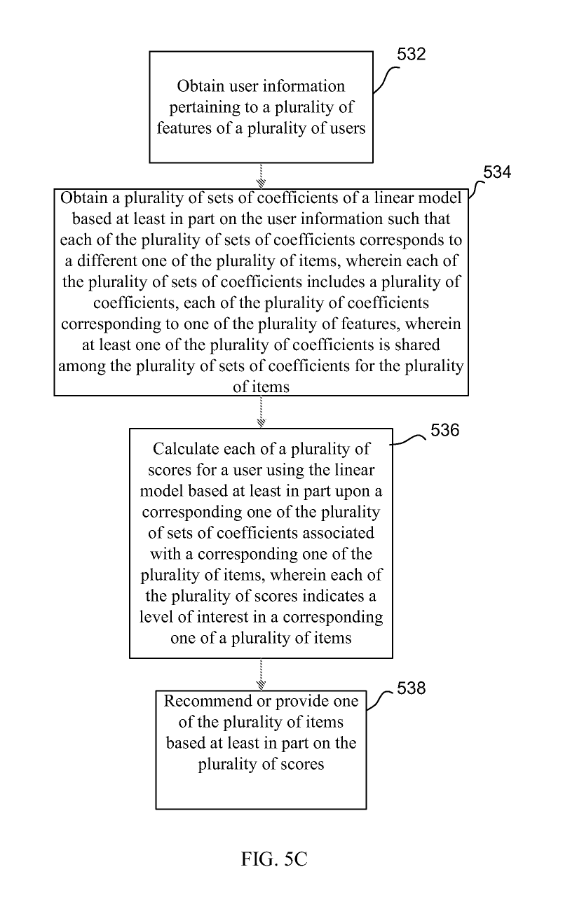

FIGS. 5A-C are process flow diagrams that together illustrate example methods of recommending one of a plurality of items in accordance with various embodiments. As shown in FIG. 5A, one of a plurality of items may be selected or recommended based at least in part upon information pertaining to a plurality of users. More particularly, information (e.g., historical data) pertaining to a plurality of users may be obtained at 502. The information may indicate values of behavioral and/or demographic features of the plurality of users. For instance, the information may indicate a response of (e.g., click behavior of) the plurality of users with respect to a plurality of items. In addition, item information pertaining to a plurality of features of the plurality of items may be obtained. For example, the item information may indicate a category of the item (e.g., finance, news), a date that the item was created or obtained (e.g., a length of time that the item has existed on the match-making web site), and/or a source of the item (e.g., web site or web page from which the item was obtained).

A plurality of scores for a user are obtained at 504 based at least in part on at least a portion of the information pertaining to the plurality of users and/or the item information, where each of the plurality of scores indicates a level of interest of the user in a corresponding one of the plurality of items. In accordance with one embodiment, a different set of coefficients may be generated for each of the plurality of items. In other words, a plurality of sets of coefficients corresponding to the plurality of items may be independent from one another. More particularly, ridge regression may be applied to the historical data pertaining to the plurality of users to obtain a plurality of sets of coefficients of a linear model such that each of the plurality of sets of coefficients corresponds to a different one of the plurality of items, wherein each of the plurality of sets of coefficients includes one or more coefficients. Each of the plurality of scores may then be calculated for the user using the linear model based upon a corresponding one of the plurality of sets of coefficients associated with a corresponding one of the plurality of items. In accordance with another embodiment, at least one of the coefficients is shared among the plurality of sets of coefficients for the plurality of items. It is important to note that while the user may be one of the plurality of users, the user need not be one of the plurality of users for which information is available.

A plurality of confidence intervals may be ascertained at 506, where each of the plurality of confidence intervals indicates a range representing a level of confidence in a corresponding one of the plurality of scores that has been generated. The plurality of confidence intervals may be generated based at least in part upon the information pertaining to the plurality of users. One of the plurality of items for which a sum of a corresponding one of the plurality of scores and a corresponding one of the plurality of confidence intervals is highest is identified at 508. The identified one of the plurality of items may be recommended or provided in association with the user at 510. For example, the identified item may be presented to the user via a graphical user interface. Data indicating whether the recommended item is selected by the user may then be stored such that historical data is updated. More particularly, the data that is stored may indicate whether the user clicked on the recommended item that was presented via a web site.

FIG. 5B is a process flow diagram illustrating an example method of recommended or providing one of a plurality of items to a user based at least in part upon information pertaining to that user. Information pertaining to a plurality of users including a user may be obtained at 522. The information may indicate values of behavioral and/or demographic features. More particularly, the information may indicate a response (e.g., click behavior) of the users with respect to a plurality of items. In addition, item information pertaining to a plurality of features of the plurality of items may be obtained.

A plurality of scores for the user may be generated at 524 based at least in part on at least a portion of the information pertaining to the plurality of users and/or item information, where each of the plurality of scores indicates a level of interest of the user in a corresponding one of a plurality of items. More particularly, the plurality of scores may be generated using information such as historical data (e.g., demographic and behavioral features) pertaining to the plurality of users. The plurality of scores may be generated by applying ridge regression to the historical data to obtain one or more coefficients associated with a linear model. Each of the plurality of scores for may then be calculated based upon the one or more coefficients.

In accordance with one embodiment, a different set of coefficients is generated for each of the plurality of items. In other words, a plurality of sets of coefficients corresponding to the plurality of items may be independent from one another. More particularly, ridge regression may be applied to the historical data to obtain a plurality of sets of coefficients of a linear model such that each of the plurality of sets of coefficients corresponds to a different one of the plurality of items, wherein each of the plurality of sets of coefficients includes one or more coefficients. Each of the plurality of scores may then be calculated using the linear model based upon a corresponding one of the plurality of sets of coefficients associated with a corresponding one of the plurality of items. In accordance with another embodiment, at least one of the coefficients is shared among the plurality of sets of coefficients for the plurality of items.

A plurality of confidence intervals may be ascertained at 526, where each of the plurality of confidence intervals indicates a range representing a level of confidence in a corresponding one of the plurality of scores that has been generated. The plurality of confidence intervals may be ascertained using at least a portion of the information pertaining to a plurality of users and/or items.

One of the plurality of items for which a sum of a corresponding one of the plurality of scores and a corresponding one of the plurality of confidence intervals is highest may be identified at 528. The identified one of the plurality of items may be recommended or provided in association with the user at 530. Data indicating whether the user selects (e.g., clicks on) the recommended item may then be stored such that historical data is updated.

FIG. 5C is a process flow diagram illustrating an example method of identifying one of a plurality of items, where the linear model for each of the plurality of items has at least one coefficient in common. As shown in FIG. 5C, user information pertaining to a plurality of features of a plurality of users may be obtained at 532. In addition, item information pertaining to a plurality of features of the plurality of items may be obtained. A plurality of sets of coefficients of a linear model may be obtained at 534 based at least in part on the user information and/or item information such that each of the plurality of sets of coefficients corresponds to a different one of the plurality of items, wherein each of the plurality of sets of coefficients includes a plurality of coefficients, each of the plurality of coefficients corresponding to one of the plurality of features, wherein at least one of the plurality of coefficients is shared among the plurality of sets of coefficients for the plurality of items. For instance, the plurality of sets of coefficients may be obtained by applying ridge regression to a set of historical data (e.g., click history) pertaining to the plurality of users. Of course, at least one of the plurality of coefficients may not be shared. Each of a plurality of scores for a user may be calculated at 536 using the linear model based at least in part upon a corresponding one of the plurality of sets of coefficients associated with a corresponding one of the plurality of items, wherein each of the plurality of scores indicates a level of interest in a corresponding one of a plurality of items. One of the plurality of items may be recommended or provided to a user at 538 based at least in part on the plurality of scores.

In one embodiment, a plurality of confidence intervals may be ascertained, where each of the plurality of confidence intervals indicates a range representing a level of confidence in a corresponding one of the plurality of scores that has been generated. The plurality of confidence intervals may be ascertained using at least a portion of the user information and/or item information. One of the plurality of items for which a sum of a corresponding one of the plurality of scores and a corresponding one of the plurality of confidence intervals is highest may be identified. Therefore, the one of the plurality of items that is recommended or provided in association with the user at 538 may be the identified item. Data indicating whether the recommended item is selected by the user may then be stored such that historical data is updated.

Evaluation Methodology

Evaluation of methods in a contextual bandit setting is typically a frustrating and time-consuming process. In practice, testing a contextual bandit approach (e.g., algorithm) on “live” data is likely to be infeasible due to logistical challenges. Therefore, offline data that was collected at a previous time may be applied offline to evaluate the contextual bandit approach. Moreover, the offline data may have been obtained using a different contextual bandit approach.

Unfortunately, because payoffs are only observed for the arms chosen by the previously applied contextual bandit algorithm, which are likely to differ from the arms chosen by a contextual bandit algorithm π being evaluated, it is difficult to evaluate the contextual bandit algorithm π only on such logged data. A process for measuring the performance of a bandit algorithm π, a rule for selecting one of a plurality of arms based upon preceding interactions with one or more users, will be described in further detail below.

We assume that there is some unknown distribution D from which context/feature vectors (x₁, . . . . xₖ) and payoffs (r1, . . . ,rk) for all arms a are obtained via a randomized logging bandit algorithm. Only the payoff rₐ is observed for the single arm a that was chosen at random. Thus, a plurality of data points may be obtained, where each data point may identify a user, an arm (e.g., news article), and a reward (e.g., whether the user clicked or did not click on the news article). This data may then be used to evaluate a bandit algorithm π. More particularly, a policy evaluator may step through a stream of logged events (e.g., data points) one by one. If the algorithm π chooses the same arm a as the one that was selected by the logging bandit algorithm, the event may be retained in a history of events and a total payoff (i.e., reward) Rₜ may be updated by adding the payoff for the event to the total payoff Rₜ. Otherwise, if the algorithm π chooses a different arm from the one that was selected by the logging bandit algorithm, then the event is entirely ignored and the policy evaluator proceeds to the next event without any other change in its state. The average payoff (e.g., average click rate) may then be ascertained by dividing the total payoff Rₜ by the number of matches (i.e., events for which the algorithm π chooses the same arm a as the one that was randomly selected by the logging bandit algorithm). Based upon the resulting average payoff, it is possible to evaluate the success of the bandit algorithm π being evaluated. Specifically, this offline-computed average payoff will be a statistically unbiased estimate of the real average payoff of π as if it were run on “live” data. This justifies the correctness and reliability of a log-driven offline evaluation methodology for contextual bandit algorithms.

Other Embodiments

The disclosed embodiments have been described with reference to document (e.g., news article) recommendation. However, it is important to note that the disclosed embodiments may be applicable to the recommendation of other types of items including, but not limited to, properties/User Favorites (e.g., categories), medical treatment options (e.g., based upon feedback indicating whether a selected treatment option provided to a patient was successful), songs, movies, etc. Accordingly, the disclosed embodiments may be applied to a content pool that changes over time in order to identify a content item from the content pool that is most suited to a particular user.

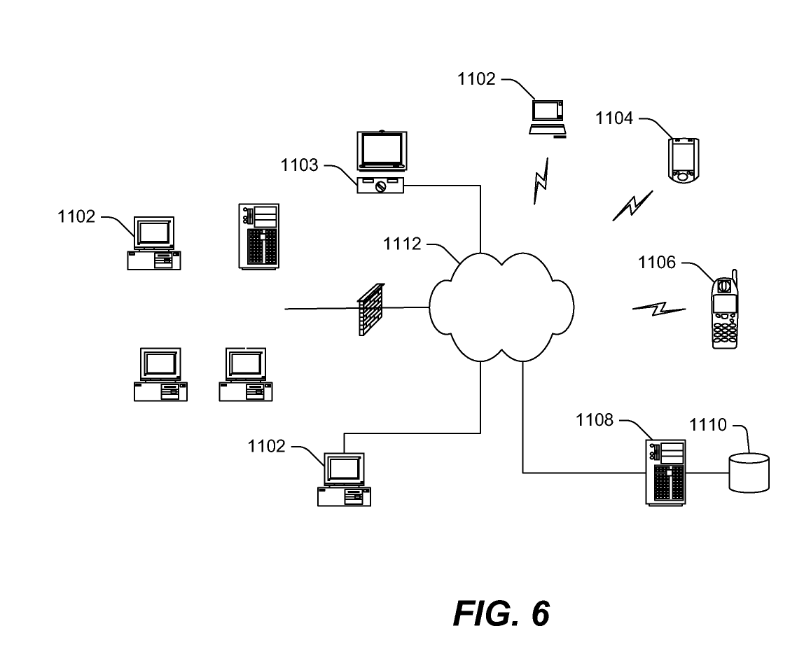

The disclosed embodiments may be implemented in any of a wide variety of computing contexts. For example, as illustrated in FIG. 6, implementations are contemplated in which users interact with a diverse network environment via any type of computer (e.g., desktop, laptop, tablet, etc.) 1102, media computing platforms 1103 (e.g., cable and satellite set top boxes and digital video recorders), handheld computing devices (e.g., PDAs) 1104, cell phones 1106, or any other type of computing or communication platform.

And according to various embodiments, input that is processed in accordance with the invention may be obtained using a wide variety of techniques. For example, a search query may be obtained via a graphical user interface from a user's interaction with a local application, web site or web-based application or service and may be accomplished using any of a variety of well known mechanisms for obtaining information from a user. However, it should be understood that such methods of obtaining input from a user are merely examples and that a search query may be obtained in many other ways.

Personalized recommendations may be provided according to the disclosed embodiments in some centralized manner. This is represented in FIG. 6 by server 1108 and data store 1110 which, as will be understood, may correspond to multiple distributed devices and data stores. The invention may also be practiced in a wide variety of network environments (represented by network 1112) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. Moreover, a system implementing various embodiments of the invention may be a portable device, such as a laptop or cell phone. The search apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, categories or content types to be displayed in association with the disclosed methods, search results, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

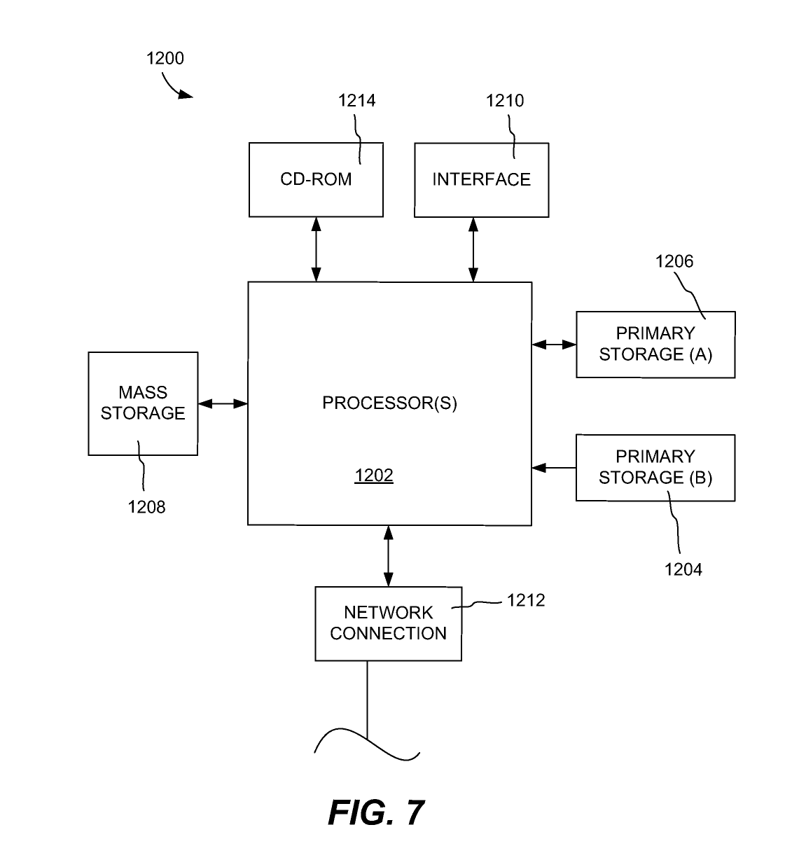

FIG. 7 illustrates a typical computer system that, when appropriately configured or designed, can serve as a system of this invention. The computer system 1200 includes any number of processors 1202 (also referred to as central processing units, or CPUs) that are coupled to storage devices including primary storage 1206 (typically a random access memory, or RAM), primary storage 1204 (typically a read only memory, or ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A computer-implemented method, comprising:
obtaining information pertaining to a plurality of users, wherein the information indicates a response of the plurality of users with respect to a plurality of items;
generating by a processor a plurality of scores for a user based at least in part on at least a portion of the information pertaining to the plurality of users, wherein each of the plurality of scores indicates a level of interest of the user in a corresponding one of the plurality of items, wherein each of the plurality of scores is generated based, at least in part, upon a corresponding one of a plurality of sets of coefficients, wherein the plurality of sets of coefficients each include a shared coefficient that is shared among the plurality of sets of coefficients;
identifying one of the plurality of items based, at least in part, upon the plurality of scores; and
recommending or providing the identified one of the plurality of items in association with the user.

2. The method as recited in claim 1, wherein the user is not one of the plurality of users.

3. The method as recited in claim 1, wherein the user is one of the plurality of users.

4. The method as recited in claim 1, wherein the information pertaining to the plurality of users further comprises:
information pertaining to demographic features and behavioral features.

5. The method as recited in claim 1, further comprising:
ascertaining a plurality of confidence intervals, each of the plurality of confidence intervals indicating a range representing a level of confidence in a corresponding one of the plurality of scores that has been generated;
wherein identifying one of the plurality of items includes selecting one of the plurality of items for which a sum of a corresponding one of the plurality of scores and a corresponding one of the plurality of confidence intervals is highest.

6. The method as recited in claim 1, wherein of the plurality of sets of coefficients is associated with a hybrid linear model.

7. The method as recited in claim 1, further comprising:
generating the plurality of sets of coefficients, at least in part, by applying ridge regression to historical data pertaining to the plurality of items.

8. The method as recited in claim 1, wherein the plurality of items change over time.

9. The method as recited in claim 1, wherein the plurality of items comprise news articles.

10. The method as recited in claim 1, wherein each of the plurality of scores is generated based, at least in part, upon a date that the corresponding one of the plurality of items was created or obtained.

11. The method as recited in claim 1, wherein the shared coefficient is generated based, at least in part, upon a category in which the plurality of items are categorized.

12. The method as recited in claim 11, wherein the category in which the plurality of items are categorized corresponds to one of a plurality of properties that are user-selectable.

13. The method as recited in claim 1, wherein the shared coefficient corresponds to one of a plurality of categories that has been selected by the user such that each of the plurality of items is categorized in the selected category.

14. A non-transitory computer-readable storage medium storing thereon computer-readable instructions, comprising:
instructions for obtaining information pertaining to a plurality of users, wherein the information indicates a response of the plurality of users with respect to a plurality of items;
instructions for generating a plurality of scores for a user based at least in part on at least a portion of the information pertaining to the plurality of users, wherein each of the plurality of scores indicates a level of interest of the user in a corresponding one of the plurality of items, wherein each of the plurality of scores is generated based, at least in part, upon a corresponding one of a plurality of sets of coefficients, wherein the plurality of sets of coefficients each include a shared coefficient that is shared among the plurality of sets of coefficients;
instructions for identifying one of the plurality of items based, at least in part, upon the plurality of scores; and
instructions for recommending or providing the identified one of the plurality of items in association with the user.

15. The non-transitory computer-readable storage medium as recited in claim 14, wherein the user is not one of the plurality of users.

16. The non-transitory computer-readable storage medium as recited in claim 14, wherein the user is one of the plurality of users.

17. The non-transitory computer-readable storage medium as recited in claim 14, wherein the information pertaining to the plurality of users further comprises:
information pertaining to demographic features and behavioral features.

18. The non-transitory computer-readable storage medium as recited in claim 14, further comprising:
instructions for ascertaining a plurality of confidence intervals, each of the plurality of confidence intervals indicating a range representing a level of confidence in a corresponding one of the plurality of scores that has been generated;
wherein identifying one of the plurality of items includes selecting one of the plurality of items for which a sum of a corresponding one of the plurality of scores and a corresponding one of the plurality of confidence intervals is highest

19. The non-transitory computer-readable storage medium as recited in claim 14, wherein each of the plurality of sets of coefficients is associated with a hybrid linear model.

20. The non-transitory computer-readable storage medium as recited in claim 14, further comprising:
instructions for generating the plurality of sets of coefficients, at least in part, by applying ridge regression to historical data pertaining to the plurality of items.

21. An apparatus, comprising:
a processor; and
a memory, at least one of the processor or the memory being adapted for:
obtaining information pertaining to a plurality of users, wherein the information indicates a response of the plurality of users with respect to a plurality of items;
generating a plurality of scores for a user based at least in part on at least a portion of the information pertaining to the plurality of users, wherein each of the plurality of scores indicates a level of interest of the user in a corresponding one of the plurality of items, wherein each of the plurality of scores is generated based, at least in part, upon a corresponding one of a plurality of sets of coefficients, wherein the plurality of sets of coefficients each include a shared coefficient that is shared among the plurality of sets of coefficients;
identifying one of the plurality of items based, at least in part, upon the plurality of scores; and
recommending or providing the identified one of the plurality of items in association with the user.

22. The apparatus as recited in claim 21, wherein the user is not one of the plurality of users.

23. The apparatus as recited in claim 21, wherein the user is one of the plurality of users.

24. The apparatus as recited in claim 21, wherein the information pertaining to the plurality of users further comprises:
information pertaining to demographic features and behavioral features.

25. The apparatus as recited in claim 21, at least one of the processor or the memory being further adapted for performing operations, comprising:
ascertaining a plurality of confidence intervals, each of the plurality of confidence intervals indicating a range representing a level of confidence in a corresponding one of the plurality of scores that has been generated;
wherein identifying one of the plurality of items includes selecting one of the plurality of items for which a sum of a corresponding one of the plurality of scores and a corresponding one of the plurality of confidence intervals is highest.

26. The apparatus as recited in claim 21, wherein each of the plurality of sets of coefficients is associated with a hybrid linear model.

27. The apparatus as recited in claim 26, at least one of the processor or the memory being further adapted for performing operations, comprising:
generating the plurality of sets of coefficients, at least in part, by applying ridge regression to historical data pertaining to the plurality of items.
